(19) United States
(12) Patent Application Publication
(10) Pub. No.: US 2003/0030949 A1
(43) Pub. Date: Feb. 13, 2003

(54) Magnetoresistive read sensor with recessed permanent magnets

(76) Inventors: Mai A. Ghaly, Bloomington, MN (US); Steven B. Slade, Chanhassen, MN (US); Kristin J. Duxstad, Edan Prairie, MN (US); David J. Larson, Northfield, MN (US); Eric W. Singleton, Greenfield, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 10/027,051

(22) Filed: Dec. 20, 2001

Related U.S. Application Data
(60) Provisional application No. 60/311,606, filed on Aug. 10, 2001.

(51) Int. Cl. G11B 5/39

(52) U.S. Cl. 360/327.31; 360/324.12

(57) ABSTRACT

A transducing head has a magnetoresistive sensor and first and second permanent magnet bias elements for providing longitudinal bias to the magnetoresistive sensor. The first and second permanent magnet bias elements are arranged on opposite sides of the magnetoresistive sensor and recessed a distance away from the magnetoresistive sensor. The transducing head of the present invention achieves increased read sensitivity by recessing the first and second permanent magnet bias elements away from the magnetoresistive sensor.

### CROSS-REFERENCE TO RELATED APPLICATION(S)

This application claims priority from provisional U.S. patent application serial No. 60/311,606 of Mai Abdelhamid Ghaly and Steven Barclay Slade, filed on Aug. 10, 2001 and entitled “Spin Valve Structure With Recessed Permanent Magnets”.

### BACKGROUND OF THE INVENTION

The present invention relates generally to the field of magnetic data storage and retrieval systems. More particularly, the present invention relates to a transducing head having a magnetoresistive sensor stabilized by permanent magnet bias elements that have been recessed a distance from the magnetoresistive sensor to increase read sensitivity of the sensor.

A transducing head of a magnetic data storage and retrieval system typically includes a magnetoresistive (MR) reader portion for retrieving magnetic data stored on a magnetic media. The reader is typically formed of several layers which include an MR sensor positioned between two gap layers, which are in turn positioned between two shield layers. The MR sensor may be any one of a plurality of MR-type sensors, including, but not limited to, AMR, GMR, spin valve and spin tunneling sensors.

When the transducing head is placed near a magnetic medium, a resistance of the MR sensor fluctuates in response to a magnetic field emanating from written transitions in the magnetic medium. By providing a sense current through the MR sensor, the resistance of the sensor can be measured and used by external circuitry to decipher the information stored on the magnetic medium. The sense current is provided to the MR sensor via a pair of current contacts.

To operate the MR sensor properly, the sensor must be stabilized against the formation of edge domains because domain wall motion results in electrical noise that makes data recovery impossible. A common way to achieve stabilization is with a permanent magnet abutted junction design in which permanent magnet bias elements directly abut opposite sides of the MR sensor.

Permanent magnets have a high coercive field (i.e., are hard magnets). The magnetostatic field from the permanent magnets stabilizes the MR sensor, prevents edge domain formation, and provides proper bias.

In recent years, MR sensor widths have been decreased to accommodate ever-increasing areal densities of magnetic media. But, with a decrease in MR sensor widths, it has been important to maintain constant MR sensor output by increasing MR sensor sensitivity. In prior art designs, this goal has been accomplished by several methods, including decreasing a thickness of a sensing layer of the MR sensor and/or reducing a thickness of the permanent magnet bias elements.

In the case of reducing the permanent magnet thickness, there have been process-control issues with creating ever-thinner permanent magnet layers. Namely, it is difficult with thinner permanent magnets to achieve consistent thicknesses of the layers, particularly across a wafer upon which tens of thousands of MR sensors are built. That is, the permanent magnets formed near the center of the wafer will be thicker than the permanent magnets formed near the edge of the wafer. Also, this may result in the two permanent magnets associated with one MR sensor having unequal thicknesses. As the thickness of the permanent magnet bias elements is decreased, this asymmetry in thickness becomes a substantially large percentage of the total MR sensor thickness. For instance, an asymmetry of 50 Angstroms would result in a 50% difference in thickness across the wafer for a targeted 100 Angstroms thick permanent magnet, whereas it would be only a 10% difference for a targeted 500 Angstroms thick permanent magnet.

Thus, there is a need for a MR sensor design having increased sensitivity without requiring a decrease in thickness of the abutted permanent magnets.

### BRIEF SUMMARY OF THE INVENTION

The present invention is a transducing head having a magnetoresistive sensor and first and second permanent magnet bias elements for providing longitudinal bias to the magnetoresistive sensor. The first and second permanent magnet bias elements are arranged on opposite sides of the magnetoresistive sensor and recessed a distance away from the magnetoresistive sensor. The transducing head of the present invention achieves increased read sensitivity by recessing the first and second permanent magnet bias elements away from the magnetoresistive sensor.

### BRIEF DESCRIPTION OF THE DRAWINGS

FIG. 1 is a cross-sectional view of a prior art transducing head.

FIG. 2 is a cross-sectional view of a transducing head in accord with the present invention.

FIG. 3 is a graph relating a read signal amplitude of a prior art transducing head to a thickness of the transducing head's first and second permanent magnet bias elements.

FIG. 4 is a graph relating a read signal amplitude of a transducing head in accord with the present invention to a distance the transducing head's permanent magnet bias element are recessed.

### DETAILED DESCRIPTION

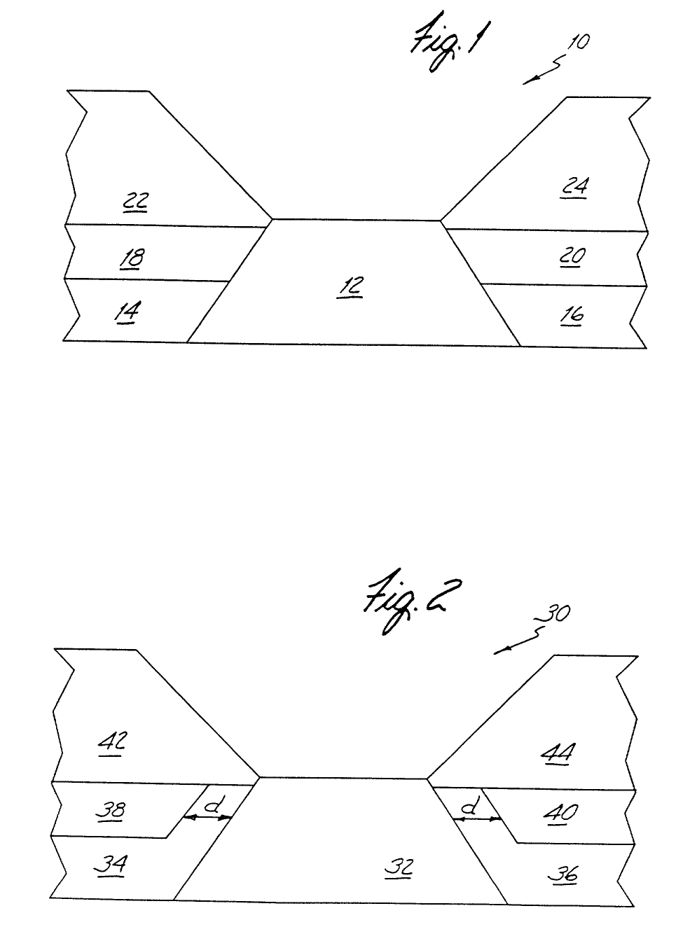

FIG. 1 is cross-sectional view of prior art transducing head 10. Transducing head 10 includes magnetoresistive (MR) sensor 12, pedestals 14 and 16, permanent magnet (PM) bias elements 18 and 20 and contacts 22 and 24.

MR sensor 12 is a multilayer device operable to sense magnetic flux from a magnetic media. MR sensor 12 may be any one of a plurality of MR-type sensors, including, but not limited to, AMR, GMR, spin valve and spin tunneling sensors. At least one layer of MR sensor 12 is a sensing layer, such as a free layer of a GMR spin valve sensor, that requires longitudinal biasing.

Pedestals 14 and 16 abut opposite sides of MR sensor 12. PM bias elements 18 and 20 are formed on pedestals 14 and 16, respectively, and similarly abut opposite sides of MR sensor 12. Contacts 22 and 24, which are formed on PM bias elements 18 and 20, respectively, also abut opposite sides of MR sensor 12.

Pedestals 14 and 16 function to elevate PM bias elements 18 and 20 to a desirable height. Pedestals 14 and 16 are typically formed of conductive materials, such as gold, rhodium, silver, tantalum, titanium or tungsten. Pedestals 14 and 16 are commonly formed with a thickness in the range of about 100 Angstroms to about 500 Angstroms.

Contacts 22 and 24 function to provide a sense current to MR sensor 12. Contacts 22 and 24 are typically formed of conductive materials, such as copper, gold or silver. Contacts 22 and 24 are commonly formed with a thickness in the range of about 0 Angstroms to about 1000 Angstroms.

PM bias elements 18 and 20 provide longitudinal biasing for the sensing layer of MR sensor 12. PM bias elements 18 and 20 are each generally formed of a hard magnetic material, such as CoCrPt. PM bias elements 18 and 20 are commonly formed with a thickness in the range of about 200 Angstroms to about 500 Angstroms.

For MR sensor 12 to operate properly, its sensing layer must be stabilized against the formation of edge domains since domain wall motion results in electrical noise that makes data recovery impossible. FIG. 1 illustrates a common approach to achieving this stabilization; that is, with a permanent magnet abutted junction design in which PM bias elements 18 and 20 abut opposite sides of MR sensor 12. The magnetostatic field from PM bias elements 18 and 20 stabilizes, prevents edge domain formation and provides proper bias for the sensing layer of MR sensor 12.

As described above in the Background of the Invention, with ever-decreasing read sensor widths, there is a need to decrease a strength of the biasing field exerted on MR sensor 12 by PM bias elements 18 and 20 to thereby increase a sensitivity of MR sensor 12. One way to increase sensitivity of MR sensor 12 is to decrease a thickness of PM bias elements 18 and 20. As also described above, however, several process-control issues exist with this prior art solution.

The present invention recognizes that a strength of the biasing field exerted on MR sensor 12 by PM bias elements 18 and 20 can be reduced by moving PM bias elements 18 and 20 away from MR sensor 12, rather than decreasing the thickness of PM bias elements 18 and 20. Thus, the present invention is a transducing head having its PM bias elements recessed a distance from its MR sensor.

FIG. 2 is a cross-sectional view of transducing head 30 in accord with the present invention. Transducing head 30 includes MR sensor 32, pedestals 34 and 36, PM bias elements 38 and 40 and contacts 42 and 44.

MR sensor 32 is a multilayer device operable to sense magnetic flux from a magnetic media. MR sensor 32 may be any one of a plurality of MR-type sensors, including, but not limited to, AMR, GMR, spin valve and spin tunneling sensors. At least one layer of MR sensor 32 is a sensing layer, such as a free layer of a GMR spin valve sensor, that requires longitudinal biasing.

Pedestals 34 and 36 abut opposite sides of MR sensor 32. Pedestals 34 and 36 are each formed of two portions: a first portion that extends outward from MR sensor 32 and a second portion that extends upward from the first portion adjacent MR sensor 32. PM bias element 38 is formed on the first portion of pedestal 34, with the second portion of pedestal 34 separating PM bias element 38 from MR sensor 32. Similarly, PM bias element 40 is formed on the first portion of pedestal 36, with the second portion of pedestal 36 separating PM bias element 40 from MR sensor 32. Contact 42 is formed on PM bias element 38 and the second portion of pedestal 34. Similarly, contact 44 is formed on PM bias element 40 and the second portion of pedestal 36. Contacts 42 and 44 abut opposite sides of MR sensor 32.

Pedestals 34 and 36 function to elevate PM bias elements 38 and 40 to a desirable height and to separate PM bias element 38 and 40 from MR sensor 32. Pedestals 34 and 36 are typically formed of conductive materials, such as gold, rhodium, silver, tantalum, titanium or tungsten. Pedestals 38 and 40 are commonly formed with a thickness in the range of about 100 Angstroms to about 500 Angstroms.

Contacts 42 and 44 function to provide a sense current to MR sensor 32. Contacts 42 and 44 are typically formed of conductive materials, such as copper, gold or silver. Contacts 42 and 44 are commonly formed with a thickness in the range of about 0 Angstroms to about 1000 Angstroms.

PM bias elements 38 and 40 provide longitudinal biasing for the sensing layer of MR sensor 32. PM bias elements 38 and 40 are each generally formed of a hard magnetic material, such as CoCrPt. PM bias elements 38 and 40 are preferably formed with a thickness in the range of about 200 Angstroms to about 500 Angstroms. PM bias elements 38 and 40 preferably are recessed no further than about 250 Angstroms. Moving PM bias elements 38 and 40 too far away from MR sensor 32 compromises the ability of PM bias elements 38 and 40 to provide adequate stabilization of MR sensor 32. In selecting a target distance d, it is important to consider the amount of variance in the deposition process. For instance, with a variance of about 50 Angstroms and a maximum distance of about 200 Angstroms to recess PM bias elements 38 and 40, a targeted distance d is preferably about 150 Angstroms. The target distance d is also dependent upon the thickness of PM bias elements 38 and 40.

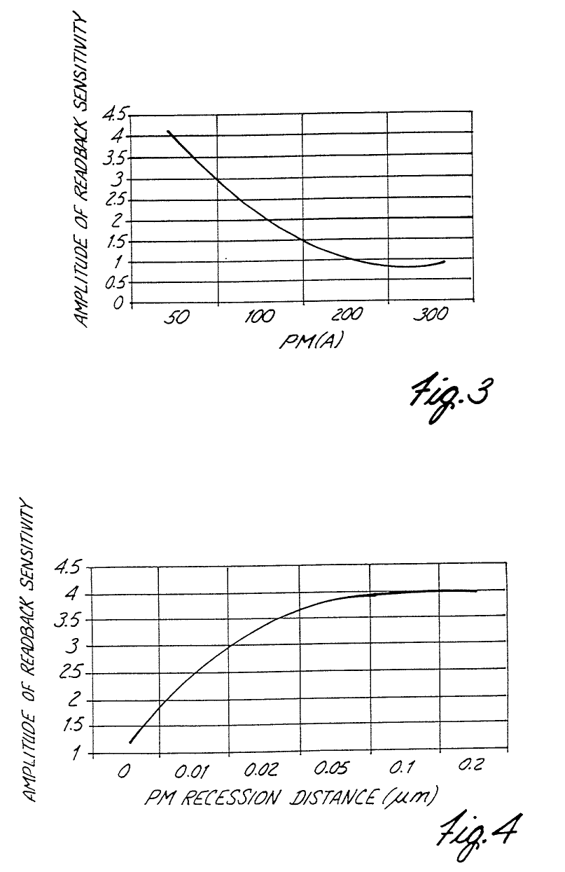

FIG. 3 is a graph relating a read signal amplitude of a prior art transducing head to a thickness of the transducing head's permanent magnet bias elements. As is evident in FIG. 3, the read signal amplitude, which relates directly to read sensitivity, increases as the thickness of the permanent magnet bias elements decreases. FIG. 3 verifies the prior art proposition that read sensitivity can be increased by decreasing the thickness of the permanent magnet bias elements.

FIG. 4 is a graph relating a read signal amplitude of a transducing head in accord with the present invention to a distance the transducing head's 200 Angstrom thick permanent magnet bias elements are recessed a distance away from the transducing head's MR sensor. Here, the read signal amplitude, or read sensitivity, increases as the permanent magnet bias elements are recessed a greater distance d away from the MR sensor. Thus, read sensitivity can be equally affected by decreasing a thickness of the permanent magnet bias elements or by moving the permanent magnet bias elements a distance away from the MR sensor.

Tests have shown that equivalent sensitivity can be realized using (1) 50 Angstroms thick non-recessed permanent magnet bias elements, (2) 200 Angstroms thick permanent magnet bias elements that have been recessed 500 Angstroms from the MR sensor; or (3) 100 Angstroms thick permanent magnet bias elements that have been recessed 50 Angstroms from the MR sensor. Importantly, the stability of the MR sensor in the second two cases (in which the permanent magnet bias elements were recessed) was not negatively affected by distancing the permanent magnetic bias elements away from the MR sensor.

In conclusion, the present invention allows for increased sensitivity of an MR sensor by recessing its permanent magnet bias elements a distance away from the MR sensor. Thus, the present invention achieves the benefit of thinner permanent magnet bias elements without the problems that arise from depositing ever-thinner permanent magnet bias elements.

Although the present invention has been described with reference to preferred embodiments, workers skilled in the art will recognize that changes may be made in form and detail without departing from the spirit and scope of the invention.

1. A magnetic data storage and retrieval system comprising:
a magnetoresistive sensor;
means for longitudinally biasing the magnetoresistive sensor, the means being spaced away from the magnetoresistive sensor.

2. The magnetic data storage and retrieval system of claim 1, wherein the means comprises a first bias element and a second bias element, the first and second bias elements being disposed on opposite sides of the magnetoresistive read sensor.

3. The magnetic data storage and retrieval system of claim 2 wherein the first and second bias elements are each permanent magnets.

4. The magnetic data storage and retrieval system of claim 2 wherein the first and second bias elements are each separated from the magnetoresistive sensor by a conductive material.

5. The magnetic data storage and retrieval system of claim 2 wherein a thickness of the first and second bias elements is in the range of about 200 Angstroms to about 500 Angstroms.

6. The magnetic data storage and retrieval system of claim 2 wherein the first and second bias elements are each separated from the magnetoresistive sensor by no more than about 250 Angstroms.

7. The magnetic data storage and retrieval system of claim 2 wherein the first and second bias elements are each separated from the magnetoresistive sensor by about 150 Angstroms.

8. A transducing head comprising:
a magnetoresistive sensor;
a first bias element; and
a second bias element, wherein the magnetoresistive sensor is positioned between the first and second bias elements, and wherein the first and second bias elements are recessed a distance from the magnetoresistive sensor.

9. The transducing head of claim 8 wherein the first and second bias elements are each permanent magnets.

10. The transducing head of claim 8 wherein the first and second bias elements are each separated from the magnetoresistive sensor by a conductive material.

11. The transducing head of claim 8 wherein a thickness of the first and second bias elements is in the range of about 200 Angstroms to about 500 Angstroms.

12. The transducing head of claim 8 wherein the distance the first and second bias elements are each recessed from the magnetoresistive sensor is no more than about 250 Angstroms.

13. The transducing head of claim 8 wherein the distance the first and second bias elements are each recessed from the magnetoresistive sensor is about 150 Angstroms.

14. A transducing head comprising:
a magnetoresistive sensor having first and second sides opposite each other;
a first pedestal having a first portion and a second portion, the first portion of the first pedestal extending laterally away from the first side of the magnetoresistive sensor and the second portion of the first pedestal extending upward from the first portion of the first pedestal adjacent the first side of the magnetoresistive sensor;
a second pedestal having a first portion and a second portion, the first portion of the second pedestal extending laterally away from the second side of the magnetoresistive sensor and the second portion of the second pedestal extending upward from the first portion of the second pedestal adjacent the second side of the magnetoresistive sensor;
a first bias element positioned upon the first portion of the first pedestal and adjacent the second portion of the first pedestal such that the second portion of the first pedestal separates the first bias element from the magnetoresistive sensor; and
a second bias element positioned upon the first portion of the second pedestal and adjacent the second portion of the second pedestal such that the second portion of the second pedestal separates the second bias element from the magnetoresistive sensor.

15. The transducing head of claim 14 wherein the first and second pedestals are each formed of a conductive material.

16. The transducing head of claim 14 wherein the first and second bias elements are each permanent magnets.

17. The transducing head of claim 14 wherein a thickness of the first and second bias elements is in the range of about 200 Angstroms to about 500 Angstroms.

18. The transducing head of claim 14 wherein the first and second bias elements are each separated from the magnetoresistive sensor by no more than about 250 Angstroms.

19. The transducing head of claim 14 wherein the first and second bias elements are each separated from the magnetoresistive sensor by about 150 Angstroms.

20. The transducing head of claim 14 and further comprising a first contact and a second contact, the first contact positioned upon the first bias element and the second portion of the first pedestal in contact with the first side of the magnetoresistive sensor and the second contact positioned upon the second bias element and the second portion of the second pedestal in contact with the second side of the magnetoresistive sensor.
